(19) United States
(12) Patent Application Publication
(10) Pub. No.: US 2016/0085212 A1
(43) Pub. Date: Mar. 24, 2016

(54) OPTICAL INFORMATION RECORDING/REPRODUCING APPARATUS, OPTICAL INFORMATION RECORDING/REPRODUCING METHOD AND DATA ARCHIVING SYSTEM

(71) Applicant: Hitachi-LG Data Storage, Inc., Tokyo (JP)

(72) Inventors: Kouichirou NISHIMURA, Tokyo (JP); Nobuo NAKAI, Tokyo (JP)

(21) Appl. No.: 14/855,465

(22) Filed: Sep. 16, 2015

(30) Foreign Application Priority Data
Sep. 19, 2014 (JP) 2014-190705

(51) Int. Cl. G03H 1/26; G11B 7/0065; G03H 1/04; H01S 3/102; H01S 3/08

(52) U.S. Cl. CPC G03H 1/2645; H01S 3/1028; H01S 3/08086; G03H 1/0465; G11B 7/0065; G03H 2001/266

(57) ABSTRACT

In a hologram recording/reproducing apparatus where a wavelength-variable laser diode having the external resonator structure is used as its light-source, stable recording/reproducing quality is ensured with respect to a change in the recording/reproducing wavelength against the expansion or contraction of a hologram medium caused by the hologram recording and the temperature change. When the output wavelength from the wavelength-variable laser diode is changed to a predetermined target wavelength, the temperature of the laser light-emission part of the wavelength-variable laser diode is controlled by a temperature control element so that the wavelength band, within which the light-emission power of the laser light-emission spectrum is higher than a predetermined light-emission power, includes the above-described predetermined target wavelength.

### INCORPORATION BY REFERENCE

The present application claims priority from Japanese application JP2014-190705 filed on Sep. 19, 2014, the content of which is hereby incorporated by reference into this application.

### BACKGROUND OF THE INVENTION

The present invention relates to a hologram recording/reproducing apparatus, a hologram recording method, and a data archiving system.

A hologram is recorded into a hologram recording medium by irradiating a signal light, on which information is superimposed by spatial modulation, and a reference light onto the hologram recording medium. In this hologram recording medium, contraction of the medium occurs after the information recording, and expansion or contraction of the medium occurs due to its temperature change. On account of this, in a hologram recording/reproducing apparatus for recording the information into the hologram recording medium, there has been known the following technology: Namely, at the time of the information recording/reproducing, the expansion or contraction of the medium is compensated by changing wavelength of the light source and irradiation angle of the reference light.

In WO2011/018836, there is disclosed the following apparatus: “An information reproducing apparatus which includes a control unit for controlling at least either of the relative irradiation angle of the reference light onto the information recording medium in response to the first error, and at least either of the wavelength of the reference light and the reproducing temperature in response to the second error”.

Also, as a configuration component which is capable of changing the wavelength of the light source, there has been known a wavelength-variable laser diode (Extended Cavity Laser Diode: ECLD). In JP-A-2011-77523, there is disclosed the configuration of the above-described ECLD where the Littrow-type external resonator structure is used.

### SUMMARY OF THE INVENTION

In the ECLD of the external resonator structure, an AR coat (Anti-Reflective Coating) processing is applied to the end surface of a semiconductor laser which becomes the light source. The laser light is oscillated by the external resonance with a diffraction grating which is set up outside the semiconductor laser. The angle between this diffraction grating and the laser light which is to enter this grating is changed, thereby changing the wavelength of the laser light which is to be outputted to the outside of the ECLD. Meanwhile, the semiconductor laser, which becomes the light source, has its spectrum characteristics. This results in a situation that the wavelength-variable range of the laser light outputted to the outside of the ECLD depends on the spectrum characteristics of the semiconductor laser. Here, in general, the wavelength range of the spectrum characteristics of the semiconductor laser is narrow. As a result, the wavelength-variable range of the outputted laser light from the ECLD also becomes narrow. Accordingly, when the contraction of the hologram recording medium caused by the recording, and the expansion or contraction of the medium caused by the temperature change (, which are caused to occur inside the hologram recording/reproducing apparatus for recording/reproducing the information) become large and significant, it was difficult to carry out the stable recording/reproducing of the information.

In view of the above-described circumstances, an object of the present invention is to ensure the stable recording/reproducing performance quality against the expansion or contraction of the hologram recording medium caused by the recording and the temperature change in the hologram recording/reproducing apparatus.

In order to accomplish the above-described object, in the present invention, the configuration disclosed in the scope of the appended claims is used as an example. More concretely, there is provided a hologram recording/reproducing apparatus for recording information as a hologram by irradiating a signal light and a reference light onto a hologram medium, the information being superimposed on the signal light, the hologram recording/reproducing apparatus including an operation control unit for controlling the internal operation of the hologram recording/reproducing apparatus, a wavelength-variable laser light-source which is capable of changing the wavelength of a laser light within a predetermined range, and which is the light source of the signal light and the reference light, and a temperature control element for controlling the temperature of the laser light-emission part of the wavelength-variable laser light-source, wherein, when changing the wavelength of the signal light and the reference light, the temperature of the laser light-emission part of the wavelength-variable laser light-source is changed by the temperature control element.

According to the present invention, it becomes possible to ensure the stable recording/reproducing performance quality against the expansion or contraction of the medium caused by the recording and the temperature change in the hologram recording/reproducing apparatus.

Other objects, features and advantages of the invention will become apparent from the following description of the embodiments of the invention taken in conjunction with accompanying drawings.

### BRIEF DESCRIPTION OF THE DRAWINGS

FIG. 1 is a control flowchart for the wavelength-variable laser diode in a first embodiment;

FIG. 2 is a block diagram of a hologram recording/reproducing apparatus in the first embodiment;

FIG. 3 is a block diagram of the recording optical system of the hologram recording/reproducing apparatus in the first embodiment;

FIG. 4 is an internal configuration diagram of the wavelength-variable laser diode in the first embodiment;

FIG. 5 is a schematic diagram for illustrating the relationship of medium temperature versus optimum recording wavelength setting in the first embodiment;

FIG. 6 is a schematic diagram for illustrating the wavelength control over the wavelength-variable laser diode in the first embodiment;

FIG. 7 is a flowchart for a hologram recording method in the first embodiment;

FIG. 8 is a block diagram of the reproducing optical system of the hologram recording/reproducing apparatus in a second embodiment;

FIG. 9 is a schematic diagram for illustrating the relationship of the medium temperature versus optimum reproducing wavelength setting in the second embodiment;

FIG. 10 is a flowchart for a hologram reproducing method in the second embodiment;

FIG. 11 is a schematic diagram for illustrating the relationship between the wavelength setting value and the wavelength-variable range of the wavelength-variable laser diode in a third embodiment;

FIG. 12 is a block diagram of the hologram recording/reproducing apparatus in a fourth embodiment;

FIG. 13 is a schematic diagram for illustrating changes in apparatus temperature, the medium temperature, and laser temperature of the hologram recording/reproducing apparatus in the fourth embodiment;

FIG. 14 is a schematic diagram for illustrating the control over medium recording wavelength and laser oscillating wavelength of the hologram recording/reproducing apparatus in the fourth embodiment;

FIG. 15 is a block diagram of the hologram recording/reproducing apparatus in the fourth embodiment;

FIG. 16 is a flowchart for a laser temperature control method of the hologram recording/reproducing apparatus in the fourth embodiment;

FIG. 17 is a flowchart for a hologram reproducing method in a fifth embodiment; and

FIG. 18 is a block diagram of a data archiving system in a sixth embodiment.

### DETAILED DESCRIPTION OF THE EMBODIMENT

### Embodiment 1

Hereinafter, as a first embodiment of the present invention, referring to the drawings, the detailed explanation will be given below concerning the configuration and operation of a hologram recording/reproducing apparatus with respect to the laser temperature control relative to the medium temperature change at the recording time.

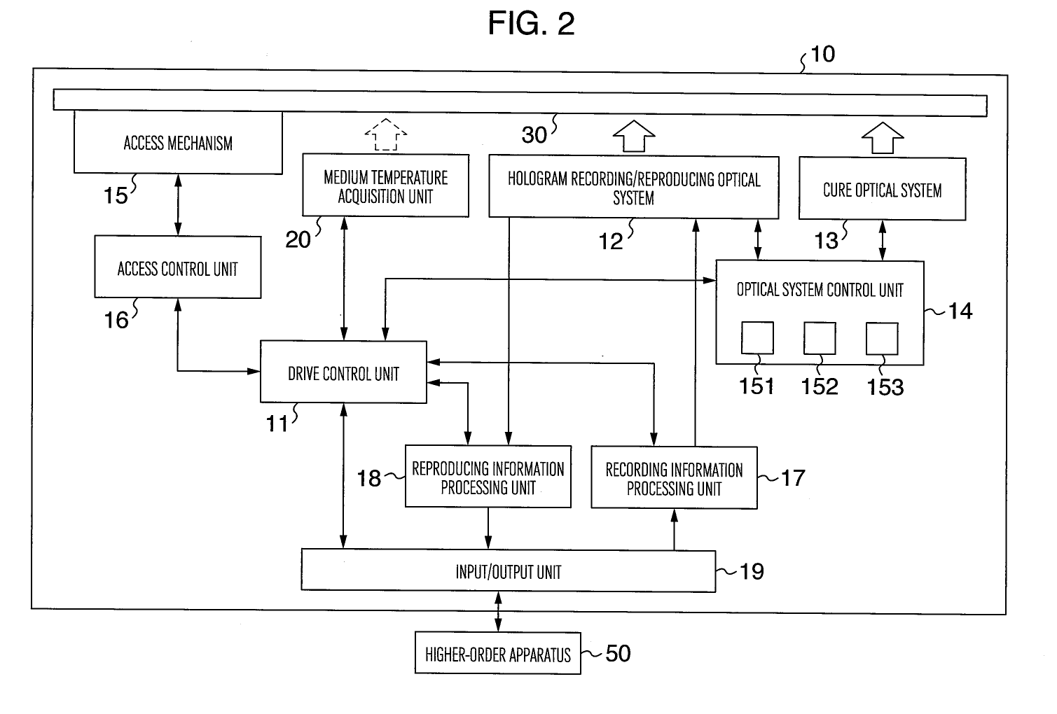

FIG. 2 is a block diagram of a hologram recording/reproducing apparatus 10 in the first embodiment of the present invention. The hologram recording/reproducing apparatus 10 in the present embodiment, from/into which the withdrawal/insertion of a hologram medium 30 is executable, includes a drive control unit 11, a hologram recording/reproducing optical system 12, a cure optical system 13, an optical system control unit 14, an access mechanism 15, an access control unit 16, a recording information processing unit 17, a reproducing information processing unit 18, and an input/output unit 19.

The hologram recording/reproducing apparatus 10 is connected to a higher-order apparatus 50 via the input/output unit 19. The apparatus 10 receives, from the higher-order apparatus 50, respective types of commands such as recoding command and reproducing command, and data to be recorded into the hologram medium 30. Moreover, the apparatus 10 transmits, to the higher-order apparatus 50, execution results of the commands and the data reproduced from the hologram medium 30.

The drive control unit 11, which controls the entire operation of the hologram recording/reproducing apparatus 10, operates the hologram recording/reproducing apparatus 10 in accordance with the respective types of commands that the apparatus 10 has received. Namely, the drive control unit 11 operates the access mechanism 15 via the access control unit 16, thereby positioning the hologram medium 30 at a predetermined position. Moreover, the unit 11 encodes the data that the apparatus 10 has received via the recording information processing unit 17, thereby converting the data into two-dimensional data. Furthermore, the unit 11 operates the hologram recording/reproducing optical system 12 and the cure optical system 13 via the optical system control unit 14, thereby recording the two-dimensional data into the hologram medium 30 as a hologram. Also, the unit 11 operates the hologram recording/reproducing optical system 12, thereby acquiring the two-dimensional data recorded into the hologram medium 30 as the hologram. Then, the unit 11 decodes the two-dimensional data via the reproducing information processing unit 18, thereby reproducing the data.

The access mechanism 15 displaces the hologram medium 30 so that an arbitrary area of the hologram medium 30 inserted into the apparatus 10 is positioned at a predetermined position relative to the hologram recording/reproducing optical system 12 and the cure optical system 13. The hologram medium 30 in the present embodiment is of circular-plate shape. The access mechanism 15 includes a spindle motor for rotating the hologram medium 30 around the central axis of this circular plate, and a slide mechanism for displacing the hologram medium 30 in a predetermined radial direction of this circular plate. Also, the access mechanism 15 includes a hologram-medium rotational angle detection unit for detecting the rotational angle of the hologram medium 30. The hologram-medium rotational angle detection unit outputs a signal corresponding to the rotational angle of the hologram medium 30.

The access control unit 16 controls the access mechanism 15, thereby positioning the hologram medium 30 at a position which is specified by the drive control unit 11. The access control unit 16 controls the rotational angle of the hologram medium 30 by driving the spindle motor on the basis of the output signal from the hologram-medium rotational angle detection unit. Also, the unit 16 controls the radial direction position of the hologram medium 30 by driving the slide mechanism.

The hologram recording/reproducing optical system 12 includes a high-coherence and 405-nm-band wavelength-variable laser light-source 101. The hologram recording/reproducing optical system 12 records the two-dimensional data by irradiating a signal light and a reference light onto the hologram medium 30 and forming a hologram. Here, the signal light is subjected to the spatial modulation with the two-dimensional data by a spatial light modulation element 110. Also, the hologram recording/reproducing optical system 12 reproduces the two-dimensional data by irradiating the reference light onto the hologram, which is recorded into the hologram medium 30, from a direction opposite to the direction at the recording time. Here, the two-dimensional data reproduced is detected by a two-dimensional optical detection element 120. Incidentally, the detailed configuration and operation of the hologram recording/reproducing optical system 12 in the present embodiment will be described later.

The cure optical system 13 irradiates a low-coherence light-flux onto the hologram medium 30, thereby performing a pre-cure and a post-cure. The pre-cure is a before-step of the hologram recording processing, which is performed with an objective that an area into which a hologram is to be recorded by irradiating the signal light and the reference light becomes likely to be exposed to light in advance. Meanwhile, the post-cure is an after-step of the hologram recording processing, which is performed with an objective that the area into which the hologram is recorded is inactivated so that the quality of the recorded hologram does not become deteriorated by an unintended light-exposure.

The optical system control unit 14 controls respective devices mounted on the hologram recording/reproducing optical system 12 and the cure optical system 13. In order to record/reproduce holograms in a multiplexed manner at a predetermined position of the hologram medium 30, the optical system control unit 14 drives the wavelength-variable laser light-source 101 of the hologram recording/reproducing optical system 12 so that the laser light-source 101 performs its light-emission with a predetermined light amount. Moreover, the unit 14 drives respective actuators, thereby performing a switching between the recording mode and the reproducing mode, and performing the control over the incident angle of the reference light which is to be irradiated onto the hologram medium 30. Also, the unit 14 drives a light-source mounted on the cure optical system 13, so that the energy suitable for the pre-cure and the post-cure becomes irradiated onto the hologram medium 30.

Furthermore, the optical system control unit 14 includes a laser power control unit 151, a laser wavelength control unit 152, and a laser temperature control unit 153, thereby performing the control over the wavelength-variable laser light-source 101 in the hologram recording/reproducing optical system 12. The details of this control, however, will be described later.

Incidentally, hereinafter, each hologram which is recorded into a predetermined area of the hologram medium 30 at a predetermined reference-light incident angle will be referred to as “a page”. Also, a hologram group which is obtained by recording a plurality of pages in a multiplexed manner into the predetermined area of the hologram medium 30 at a plurality of reference-light incident angles will be referred to as “a book”.

The recording information processing unit 17 converts the data received from the higher-order apparatus 50 into the two-dimensional data to be displayed on the spatial light modulation element 110. Namely, the unit 17 divides the received data into a plurality of data strings. After that, the unit 17 applies the addition of a CRC (Cyclic Redundancy Check)-use parity, a scrambling processing, and the addition of an error-correcting code to these data strings. Moreover, the unit 17 converts these data strings into two-dimensional data by the amount of subpages. Furthermore, the unit 17 collects a plurality of subpages, thereby configuring the two-dimensional data by the amount of one page. Finally, after adding a marker to the two-dimensional data by the amount of one page, the unit 17 transfers the two-dimensional data to the spatial light modulation element 110.

The reproducing information processing unit 18 reproduces the data from the image data detected by a two-dimensional optical detection element 116. Namely, the unit 18 corrects a distortion of the image by detecting the image position using the marker of the received image data as the criterion. Moreover, the unit 18 applies a binarization processing to the image data, and removes the marker, thereby acquiring the two-dimensional data by the amount of one page. Furthermore, the unit 18 converts the two-dimensional data into the plurality of data strings on each subpage basis. Finally, the unit 18 applies the error-correcting processing, a descrambling processing, and the CRC processing to these data strings, thereby acquiring the data.

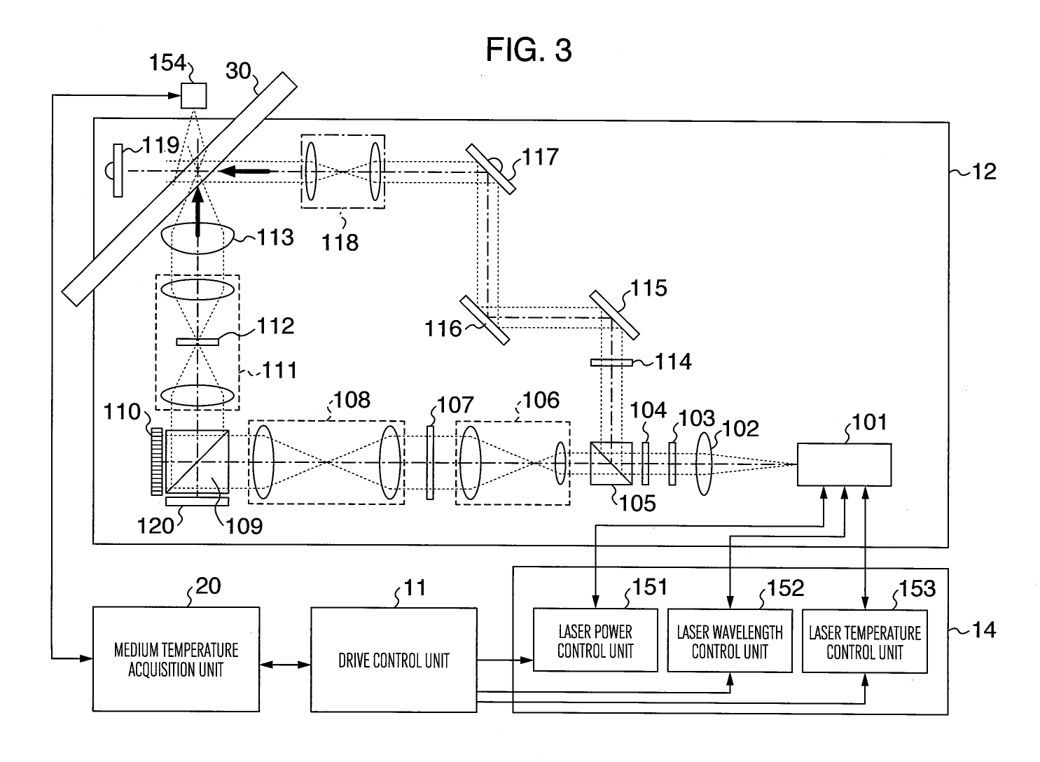

Next, the explanation will be given below concerning the detailed configuration and operation of the hologram recording/reproducing optical system 12. FIG. 3 is a block diagram of the hologram recording/reproducing optical system 12 in the first embodiment of the present invention. FIG. 3 indicates the state at the time of the hologram recording.

A high-coherence light-flux is emitted from the wavelength-variable laser light-source 101 which is adjustable to a predetermined 405-nm-band wavelength. Next, this light-flux is caused to pass through a collimator lens 102, thereby being converted into a parallel light-flux. Moreover, this parallel light-flux is guided to a half-wave plate 104 via a shutter unit 103.

The half-wave plate 104 is configured such that it is made rotatable around the optical axis by being mounted on an actuator. Rotating the half-wave plate 104 at a predetermined angle allows the light-flux that has entered the plate 104 to be converted into a light-flux whose P-polarization component and S-polarization component becomes equal to a predetermined light-amount ratio. This light-flux is separated into the P-polarization component and the S-polarization component by a polarization element 105 which follows the plate 104.

The P-polarization light-flux, which has passed through the polarization element 105, is defined and used as a signal light. Moreover, the light-flux diameter of the signal light is enlarged by a beam expander 106. After that, the signal light is caused to pass through a phase mask 107, relay lenses 108, and a polarization element 109, then being caused to enter the spatial light modulation element 110. Furthermore, the signal light is reflected by the spatial light modulation element 110 which displays a predetermined two-dimensional data. This modulates the signal light in a spatial manner, and converts its polarization direction into the S-polarization direction. In addition, the signal light, on which the two-dimensional data is superimposed by the spatial modulation, is reflected by the polarization element 109, thereby being caused to pass through relay lenses 111 and a spatial filter 112. Finally, the signal light is focused onto the hologram medium 30 by an objective lens 113.

Meanwhile, the S-polarization light-flux, which is reflected by the polarization element 105, is defined and used as a reference light. Moreover, the polarization direction of the reference light is converted into a predetermined polarization direction by a half-wave plate 114. Furthermore, the reference light is reflected by a total reflection mirror 115, a total reflection mirror 116, and a galvanometer mirror 117. Finally, the reference light is irradiated onto the hologram medium 30 by a scanner lens 119. The galvanometer mirror 117 is configured such that its reflection angle is made changeable by an actuator. Controlling the reflection angle of the galvanometer mirror 117 allows the incident angle of the reference light, which is to be irradiated onto the hologram medium 30, to be set at a predetermined angle.

The signal light and the reference light are irradiated onto the hologram medium 30 in such a manner that they are overlapped with each other. This causes an interference-based hologram to be formed within the hologram medium 30, thereby recording the two-dimensional data superimposed on the signal light. Also, irradiating the reference light at different incident angles allows a plurality of pages to be recorded into a single book in a multiplexed manner.

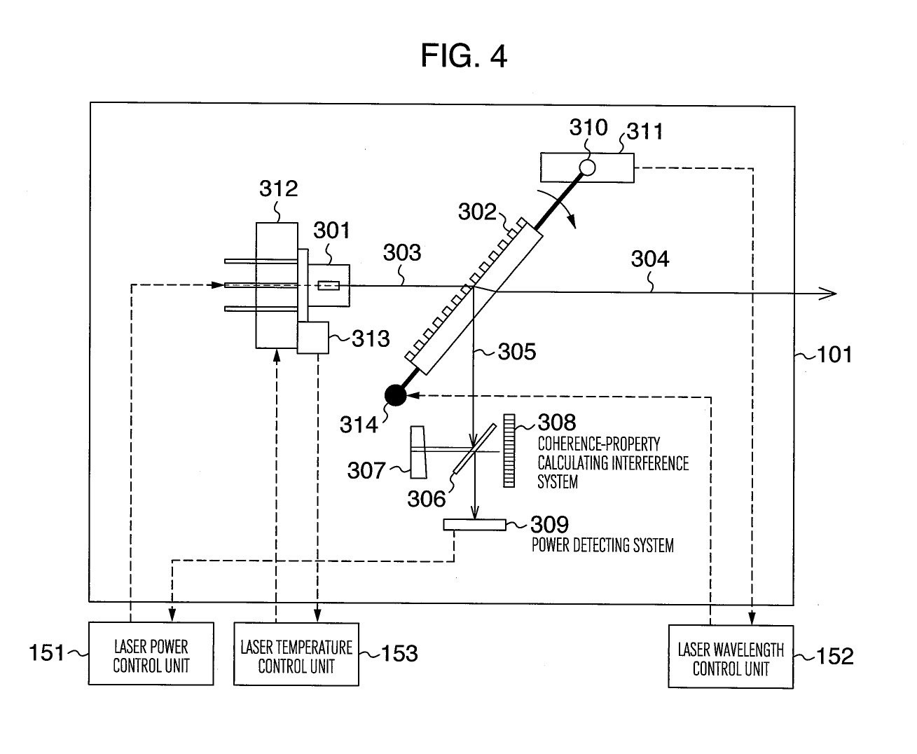

Hereinafter, the detailed explanation will be given below concerning the operations of the wavelength-variable laser light-source 101 and the respective control blocks of the optical system control unit 14 for controlling this laser light-source 101. FIG. 4 illustrates the internal configuration of the Littrow-type wavelength-variable laser light-source 101 in the first embodiment of the present invention. A reference numeral 301 denotes a blue semiconductor laser diode where GaAs or the like is used. A laser light 303 emitted therefrom is diffracted by a transmission-type diffraction grating 302. At this time, a motor 314 fixed to the diffraction grating 302 is rotated based on a command value from the laser wavelength control unit 152, thereby changing the relative angle between the incident laser light 303 and the diffraction grating 302. This causes a return light to the semiconductor laser diode 301 to be controlled to change the interference condition, thereby making it possible to change the wavelength of a laser light 304 to be outputted from the wavelength-variable laser light-source 101. The confirmation of the wavelength of the outputted laser light 304 is carried out by a mechanism for monitoring the angle-set value of the diffraction grating 302. In the present embodiment, this mechanism is a mechanism for detecting, with a position detecting sensor 311, the reflection of the laser light irradiated from the laser diode 301 onto the end surface of the diffraction grating 302. The confirmation result is inputted into the laser wavelength control unit 152.

The laser power is controlled in such a manner that a command value from the laser power control unit 151 is changed to a current or voltage, and is inputted into a terminal of the laser diode 301. The confirmation of the power of the outputted laser light 304 is carried out by inputting a diffraction light 305, which is generated from the diffraction grating 302, into a detector 309 via a half mirror 306. The confirmation result is inputted into the laser power control unit 151.

A temperature control element 312, which is configured using the Peltier mechanism or the like, is controlled based on a command value from the laser temperature control unit 153. The laser temperature is directly acquired by a temperature sensor 313, or is acquired as the temperature of the temperature control element 312. The laser temperature acquired is inputted into the laser temperature control unit 153.

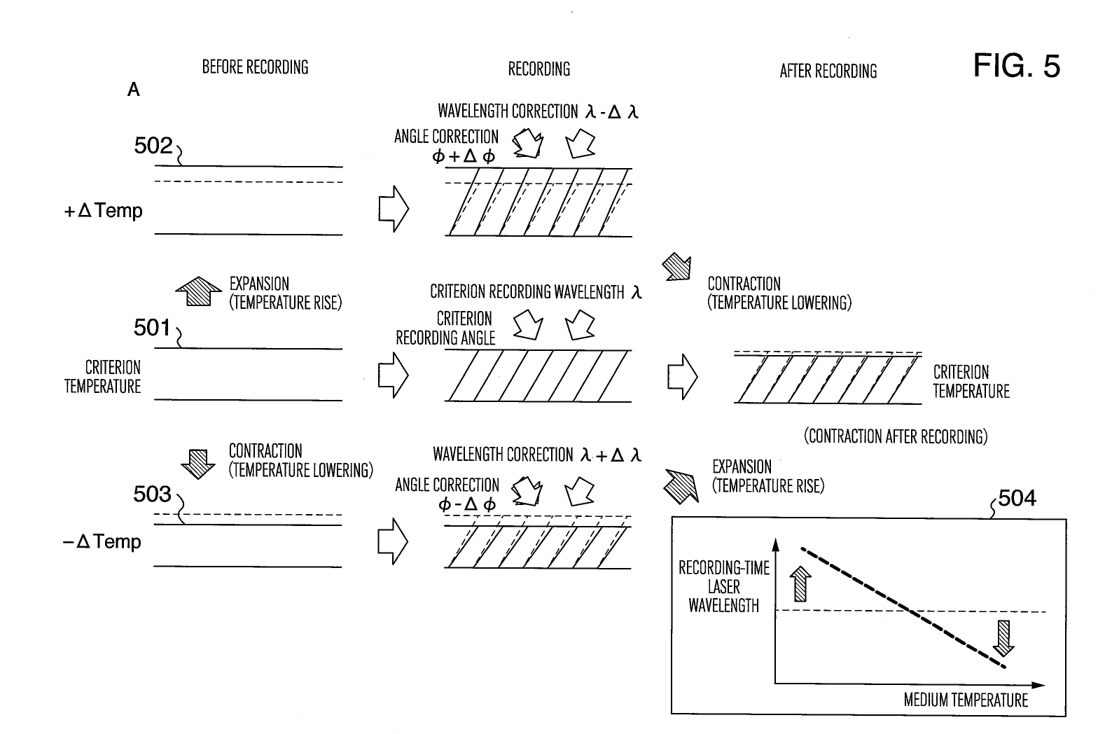

Next, the explanation will be given below regarding the wavelength control with respect to the temperature change in the hologram medium at the recording time. FIG. 5 is a schematic diagram for illustrating a change in the temperature of the medium and a change in the recorded hologram. Namely, if the medium temperature rises with reference to a criterion temperature, the hologram medium 501 expands as is indicated by a reference numeral 502. Meanwhile, if the medium temperature lowers, the hologram medium 501 contracts as is indicated by 503. In view of this situation, the expansion or contraction of the medium caused by the temperature change at the recording time is compensated. Namely, the recording is always performed such that a hologram, which is basically the same as the hologram in the case where the recording is performed at a criterion laser wavelength and a criterion reference-light angle at the criterion temperature, is recorded into the medium. Concretely, if the medium temperature rises, the recording is performed such that the laser wavelength is shortened, and the reference-light angle is increased. Meanwhile, if the medium temperature lowers, the recording is performed such that the laser wavelength is lengthened, and the reference-light angle is decreased. This control always allows a hologram, which is basically the same as the hologram in the case where the recording is performed at the criterion temperature, the criterion laser wavelength, and the criterion reference-light angle, to be recorded into the medium. A reference numeral 504 indicates the relationship between the medium temperature and the recording-time laser wavelength in the above-described control.

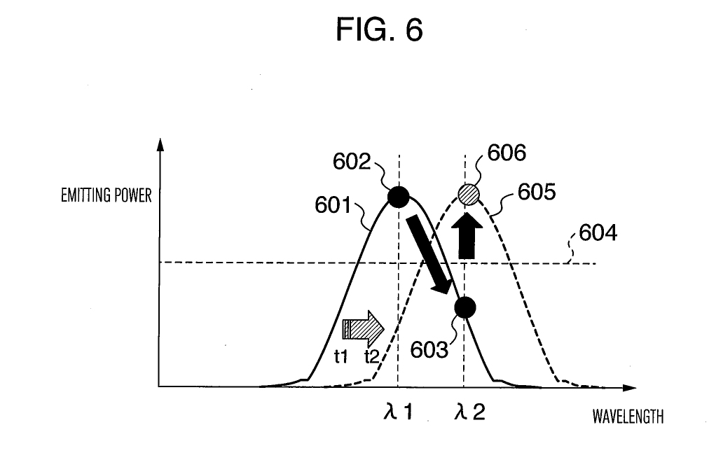

Here, consideration is given to the case where the laser wavelength is changed from λ1 to λ2. FIG. 6 illustrates the relationship between the semiconductor laser wavelength and the emitted laser power in the present embodiment. A reference numeral 601 indicates the laser oscillation spectrum at the laser temperature t1. When the laser wavelength is changed from λ1 to λ2 by rotating the diffraction grating 302 described earlier, the emitted laser power under the same current condition becomes lowered from 602 to 603. As a result of this, if the emitted laser power has fallen below a laser power value 604 which is necessary for the hologram recording, it becomes difficult to perform the recording based on a predetermined light-exposure time for ensuring the recoding transfer rate. Also, at the foot portion of the laser oscillation spectrum, the laser's longitudinal-mode stability becomes deteriorated. As a result, the stable hologram recording becomes difficult to perform. As a method for compensating these problems, the laser temperature is changed from t1 to t2 by heightening the temperature of the laser diode 301 using the temperature control element 312 illustrated in FIG. 4. As a result of this laser temperature change, the laser oscillation spectrum is changed from 601 to 605. This makes it possible to obtain sufficient emitted laser power indicated by 606, even in the case where the laser is oscillated at the wavelength λ2.

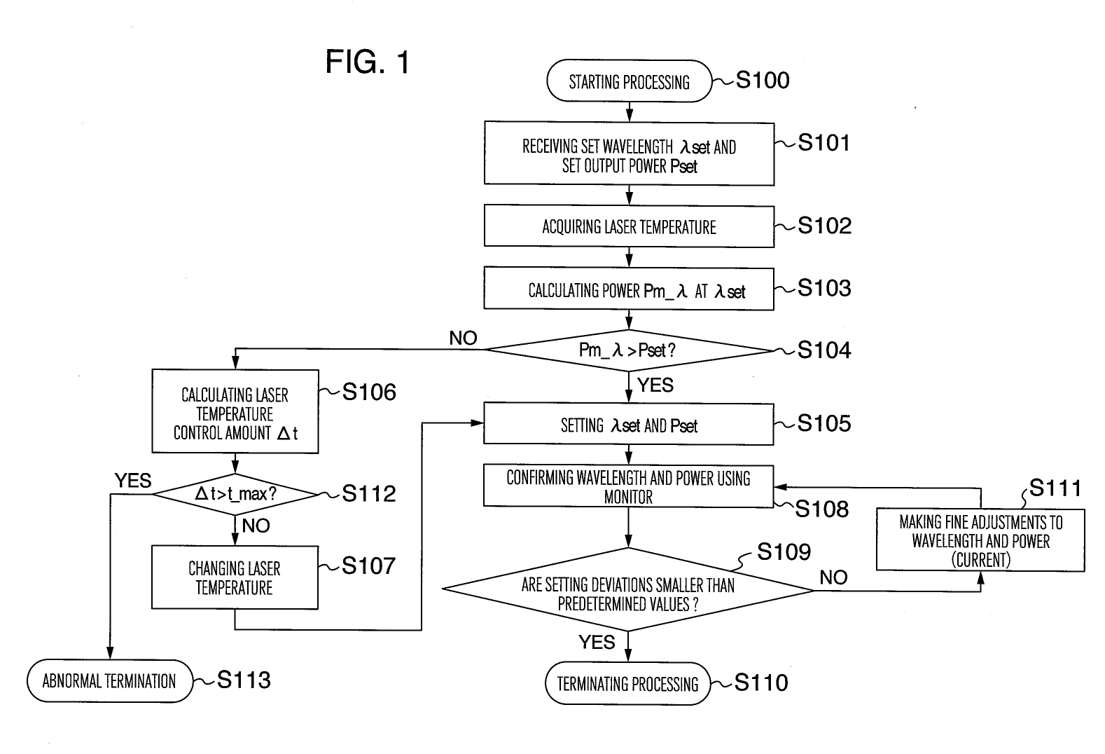

FIG. 1 illustrates a flowchart for the laser wavelength setting processing and the laser temperature setting processing in the wavelength-variable laser light-source 101 in the present embodiment. Here, the above-described contents are incorporated into this flowchart.

At a processing S100, the laser wavelength setting processing is started. Then, at a processing S101, the values of a set wavelength λset and a set output power Pset are received from the drive control unit 11. Next, at a processing S102, the laser temperature is acquired. At a processing S103, the output power Pm_λ at the wavelength λset is calculated from the laser-oscillation-spectrum data at this laser temperature registered into the apparatus in advance. Moreover, at a processing S104, the comparison is made between the calculated output power Pm_λ and the set output power Pset. Then, if Pm_λ is larger than Pset at the processing S104, at a processing S105, the diffraction grating 302 is rotated, thereby setting the output wavelength of the wavelength-variable laser light-source 101 at λset, and a laser current value which is equivalent to the laser power Pset. Meanwhile, if Pm_λ is smaller than Pset at the processing S104, at a processing S106, the laser temperature control amount Δt is calculated in which the laser oscillation spectrum becomes its peak at λset as was indicated in FIG. 6. Furthermore, at a processing S112, if Δt exceeds a laser tolerable temperature variable range t_max, an abnormal termination holds at a processing S113. Here, a processing is requested, such as stop of the recording/reproducing operation by the apparatus. Meanwhile, if, at the processing S112, Δt is judged to be smaller than t_max, at a processing S107, the laser temperature is changed. Then, the output wavelength and the laser current are set as is the case with above-described processing S105. After the settings are completed, at a processing S108, the output wavelength and the output power are confirmed using a monitor. In addition, at a processing S109, deviation amounts from the set values λset and Pset are confirmed. Then, if the deviation amounts are smaller than predetermined values determined in advance at the processing S109, at a processing S110, the processing is terminated. Meanwhile, if the deviation amounts are larger than the predetermined values, there is a possibility that there occurs the longitudinal-mode instability due to a mode-hop. Accordingly, at a processing S111, the wavelength and the power are subjected to fine adjustments by the diffraction grating and the laser current. Then, the processing returns to the processing S108 again.

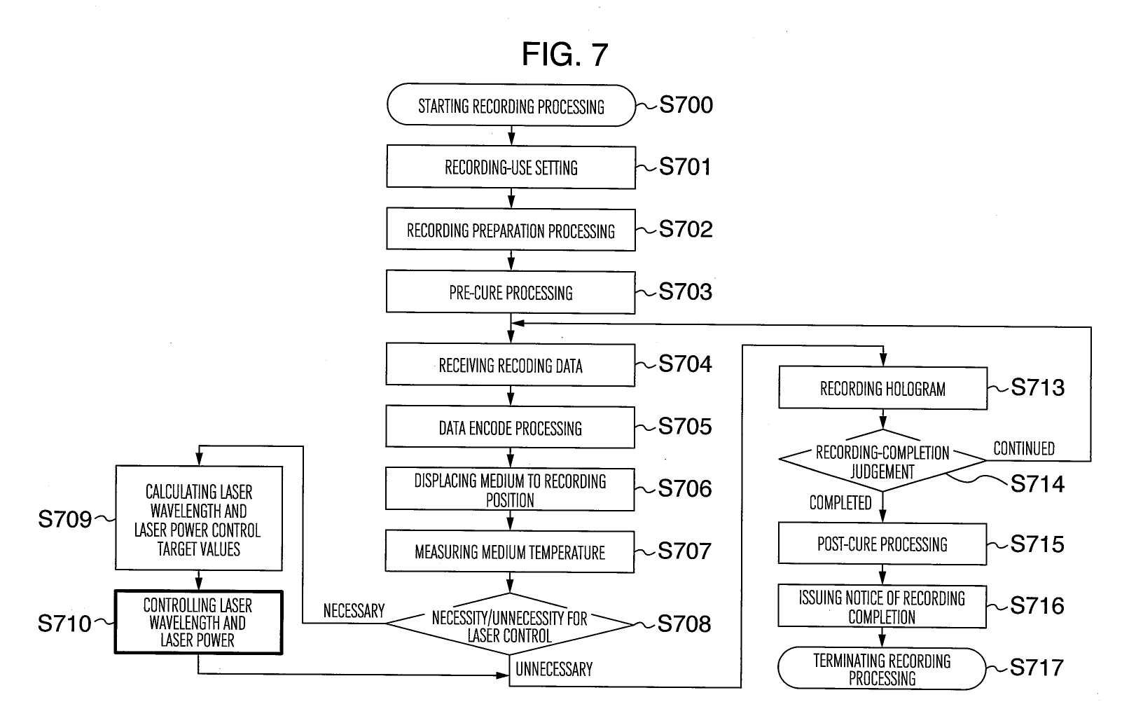

Furthermore, FIG. 7 illustrates a flowchart for the hologram recording method to which the above-described laser wavelength setting processing is applied. Namely, referring to FIG. 7, the explanation will be given below concerning the processing at the hologram recording time.

At S700, the recording processing is started. After that, at S701, the respective actuators of the hologram recording/reproducing optical system 12 are driven, and are set into the recording mode. As a result, the laser light-source 101 performs the light-emission in accordance with the setting of recording-use criterion wavelength and criterion power. Next, at S702, a recording preparation processing is applied to the inserted hologram medium 30. The present recording preparation processing includes the following processing as its one example: Check processing of the recording possibility/impossibility into the hologram medium 30, correction processing of eccentricity and tilt of the medium 30, acquisition of the management information, and adjustment of the respective set values of the hologram recording/reproducing optical system 12 into the setting fitted to the medium 30, allocation processing of a recoding area to the medium 30, and the like.

At S703, the pre-cure is applied to the recoding area of the hologram medium 30 by the cure optical system 13. At S704, the recoding data is received from the higher-order apparatus 50. At S705, the encoding processing of the recoding data is performed by the recording information processing unit 17. At S706, the hologram medium 30 is positioned at a position at which a book is recorded by the hologram recording/reproducing optical system 12.

Moreover, at S707, the temperature of the recoding area of the hologram medium 30 is measured. At S708, the judgement on the laser control necessity/unnecessity is made from a temperature difference with the previous recording time.

If, at S708, the laser control is judged to be unnecessary, at 5713, the hologram is recorded into the hologram medium 30. In the present embodiment, the galvanometer mirror 117 is changed to a predetermined reflection angle during the cut-off time-period of the shutter unit 103, and the reflection angle is maintained during the pass-through time-period thereof. This allows a plurality of pages to be recorded into a predetermined book in a multiplexed manner.

Meanwhile, if, at S708, the laser control is judged to be necessary, at 5709, the laser wavelength and laser power control target values necessary for the recording are calculated. Furthermore, at S710, the laser wavelength and laser power control is carried out which was explained in FIG. 1 described earlier. After that, at 5713, the hologram is recorded into the hologram medium 30 as is the case with the above-described explanation.

At 5714, it is judged whether or not the entire data, whose recording is specified by the higher-order apparatus 50, has been recorded already. Then, if unrecorded data remains, the processing returns to S704, then continuing the recoding processing. Meanwhile, if the recording of the entire data is completed, at 5715, the post-cure is applied to the recoding area. Finally, at S716, the notice of the recording completion is issued to the higher-order apparatus 50, and, at S717, the recording processing is terminated.

As having been explained so far, in the hologram recording method in the present embodiment, when the recording wavelength is required to be changed due to the medium's contraction caused by the recording, and the medium's expansion or contraction caused by the temperature change, the laser temperature of the wavelength-variable laser light-source 101 is controlled properly. This allows the laser oscillation spectrum to be controlled into an optimum oscillation range with respect to the recording wavelength. As a result, it becomes possible to ensure the laser power and the longitudinal-mode stability which are necessary for the hologram recording. This makes it possible to implement the sable hologram recording against the medium's variation caused by the temperature change.

Incidentally, in the present embodiment, the blue semiconductor laser diode is employed as the laser light-source 101. The present invention, however, is not limited to the present contents. Also, concerning the angle detection of the diffraction grating 302, the coherence property of the outputted laser light, and the power detecting method as well, the present invention is not limited to the contents of the present embodiment.

### Embodiment 2

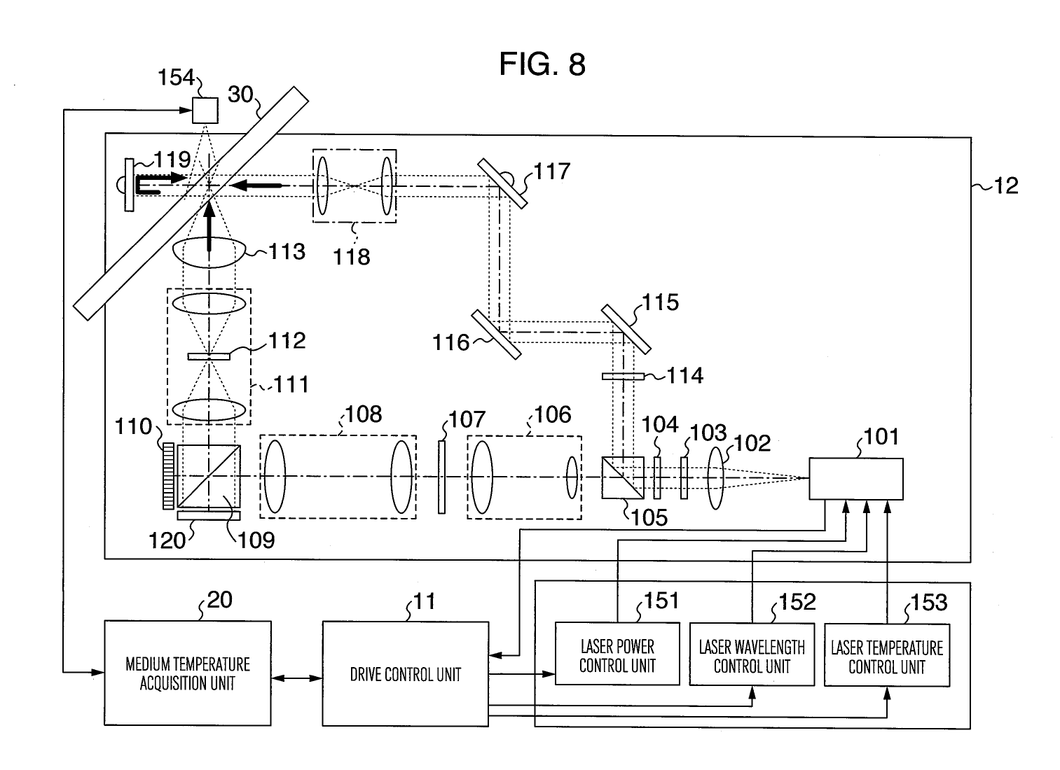

Hereinafter, as a second embodiment of the present invention, referring to the drawings, the detailed explanation will be given below concerning the configuration and operation of the hologram recording/reproducing apparatus with respect to the laser temperature control relative to the medium temperature change at the reproducing time. FIG. 8 is a block diagram of the hologram recording/reproducing optical system 12 in the first embodiment of the present invention. FIG. 8 indicates the state at the time of the hologram reproducing. In FIG. 8, the same reference numerals are affixed to the blocks and parts which have the same functions illustrated in FIG. 3.

In the reproducing mode, the reference light is irradiated onto the hologram medium 30 in such a state that the half-wave plate 104 is rotated at an angle at which the P-polarization component of the emitted light becomes its maximum value. Moreover, the reference light, which has passed through the hologram medium 30, is reflected at a predetermined reflection angle by a galvanometer mirror 119 whose angle is adjustable. The reflected reference light is caused to enter the hologram medium 30 again as a reproducing-use reference light. Furthermore, the reproducing-use reference light is diffracted by the hologram recorded into the hologram medium 30. The diffracted reference light, as a reproduced light, passes through the objective lens 113, the relay lenses 111, the spatial filter 112, and the polarization element 109, then entering the two-dimensional optical detection element 120. The two-dimensional optical detection element 120 outputs a signal responding to the light intensity of the reproduced light which has entered each cell of the element 120. The galvanometer mirror 117 and the galvanometer mirror 119 are set at angles corresponding to each page, thereby reproducing a predetermined page of a predetermined book.

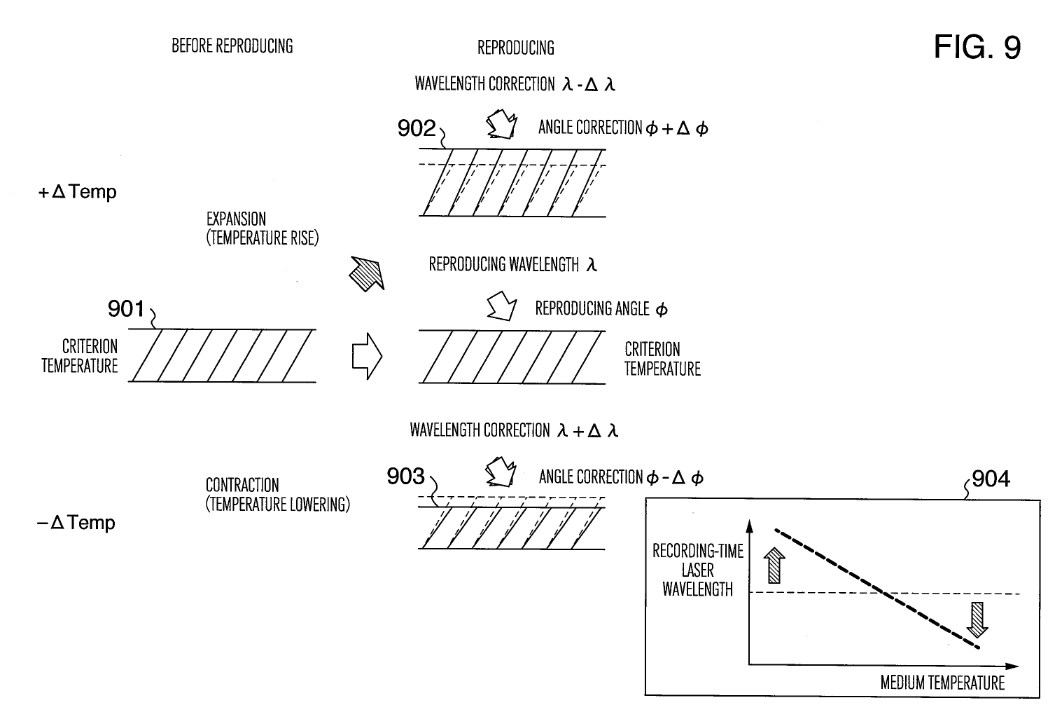

Next, the explanation will be given below regarding the wavelength control with respect to the temperature change in the hologram medium at the reproducing time. FIG. 9 is a schematic diagram for illustrating a change in the recorded hologram caused by a change in the temperature of the medium into which the hologram was recorded. Namely, the hologram is now recorded into the hologram medium 901 at the criterion laser wavelength and the criterion reference-light angle at the criterion temperature. Here, if the medium temperature rises, this hologram medium 901 expands as is indicated by a reference numeral 902. Meanwhile, if the medium temperature lowers, the hologram medium 901 contracts as is indicated by 903. In order to reproduce the information properly from this medium, if the medium temperature rises, the reproducing is performed such that the laser wavelength is shortened, and the reference-light angle is increased. Meanwhile, if the medium temperature lowers, the reproducing is performed such that the laser wavelength is lengthened, and the reference-light angle is decreased. A reference numeral 904 indicates the relationship between the medium temperature and the recording-time laser wavelength in the control in the present embodiment.

Concerning the switching of the laser wavelength at the reproducing time as well, as is the case with the recording time described earlier, the use of the characteristics of the foot portion of the laser oscillation spectrum makes it impossible to obtain the sufficient emitted laser power. As a result, the reference light having the sufficient power is not irradiated onto the recorded hologram. This results in shortage of the reproduced light amount, thereby lowering the reproduced signal quality, i.e., SNR (Signal-to-Noise Ratio). In view of this situation, as described earlier, the laser temperature is changed from t1 to t2 by heightening the temperature of the laser diode 301 using the temperature control element 312 illustrated in FIG. 4. As a result of this laser temperature change, the laser oscillation spectrum is changed from 601 to 605 as is illustrated in FIG. 6. This makes it possible to obtain the sufficient emitted laser power, even in the case where the laser is oscillated under the condition that the laser wavelength is changed.

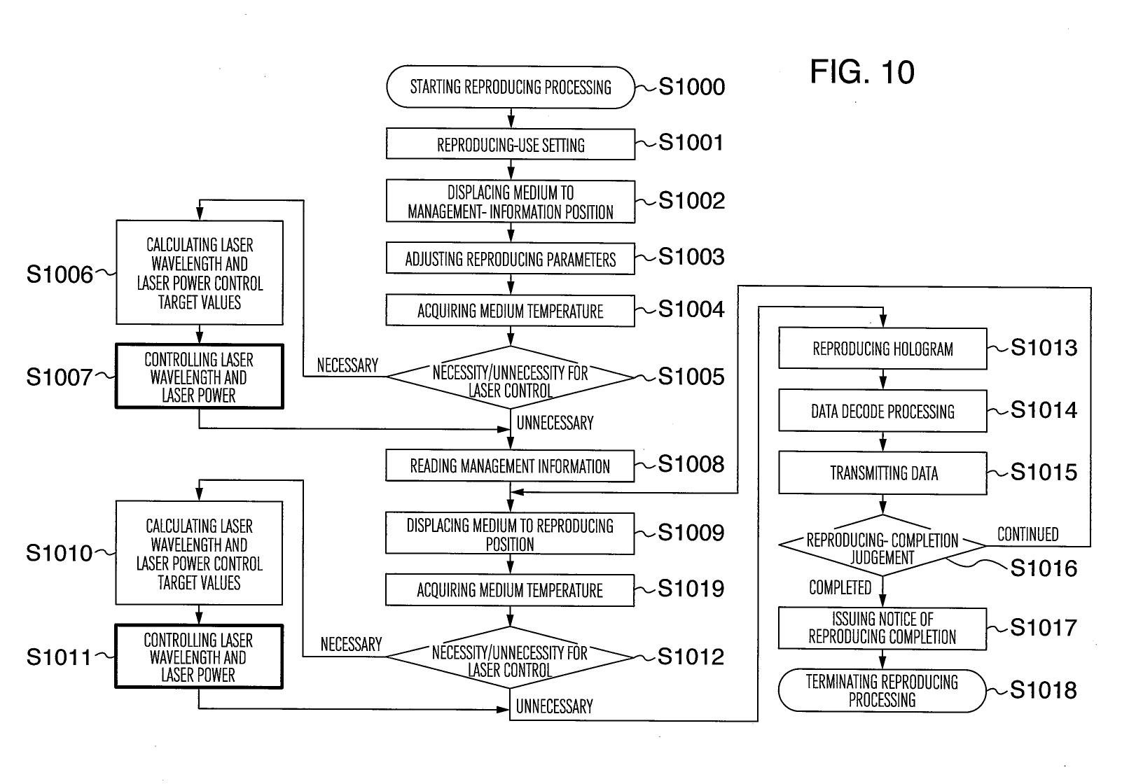

FIG. 10 illustrates a flowchart for the hologram reproducing method to which the above-described laser processing is applied. Namely, referring to FIG. 10, the explanation will be given below concerning the processing at the hologram reproducing time.

At S1000, the reproducing processing is started. After that, at S1001, the respective actuators of the hologram recording/reproducing optical system 12 are driven, and are set into the reproducing mode. As a result, the laser light-source 101 performs the light-emission in accordance with the setting of reproducing-use criterion wavelength and criterion power, and the shutter unit 103 is opened.

At S1002, the hologram medium 30 is positioned at a position at which management information can be read by the hologram recording/reproducing optical system 12. At S1003, the respective set values of the hologram recording/reproducing optical system 12 are adjusted into the reproducing-use set values. At S1004, the medium temperature is acquired. From its result, at S1005, the laser control necessity/unnecessity for reading the management information is confirmed.

If, at S1005, the laser control is judged to be unnecessary, at S1008, the management information is read.

Meanwhile, if, at S1005, the laser control is judged to be necessary, at S1006, the laser wavelength and laser power control target values necessary for the recording are calculated. Furthermore, at S1007, the laser wavelength and laser power control is carried out which was explained in FIG. 1 of the first embodiment described earlier. After that, at S1008, the management information is read as is the case with the above-described explanation.

Based on the management information read at S1008, at S1009, the hologram medium 30 is displaced onto the position of a book to be reproduced.

At S1019, the medium temperature is acquired. From its result, at S1012, the laser control necessity/unnecessity for reproducing the data about the book is confirmed.

The processing ranging from the judgement at S1012 to the hologram reproducing at S1013 are the same as the processing ranging from S1005 to S1008 described earlier. Accordingly, the explanation thereof will be omitted here.

At S1013, the reference light is irradiated onto a page to be reproduced, and the reproduced light is detected by the two-dimensional optical detection element 120. At S1014, the data is decoded from the detection signal by the reproducing information processing unit 18. At S1015, the reproduced data is transmitted to the higher-order apparatus 50.

At S1016, it is judged whether or not the entire data, whose recording is specified by the higher-order apparatus 50, has been reproduced already. Then, if unreproduced data remains, the processing returns to S1009, then continuing the reproducing processing. Meanwhile, if the reproducing of the entire data is completed, at S1017, the notice of the reproducing completion is issued to the higher-order apparatus 50, and the reproducing processing is terminated (S1018).

As having been explained so far, in the hologram reproducing method in the present embodiment, when the reproducing wavelength is required to be changed due to the medium's contraction caused by the recording, and the medium's expansion or contraction caused by the temperature change, the laser temperature of the wavelength-variable laser light-source is controlled properly. This allows the laser oscillation spectrum to be controlled into an optimum oscillation range with respect to the reproducing wavelength. As a result, it becomes possible to ensure the laser power and the longitudinal-mode stability which are necessary for the hologram recording. This makes it possible to implement the sable hologram reproducing against the medium's variation caused by the temperature change.

### Embodiment 3

Hereinafter, as a third embodiment of the present invention, referring to the drawings, the detailed explanation will be given below concerning the relationship among the wavelength command value, the laser temperature control, and the outputted laser wavelength of the wavelength-variable laser light-source.

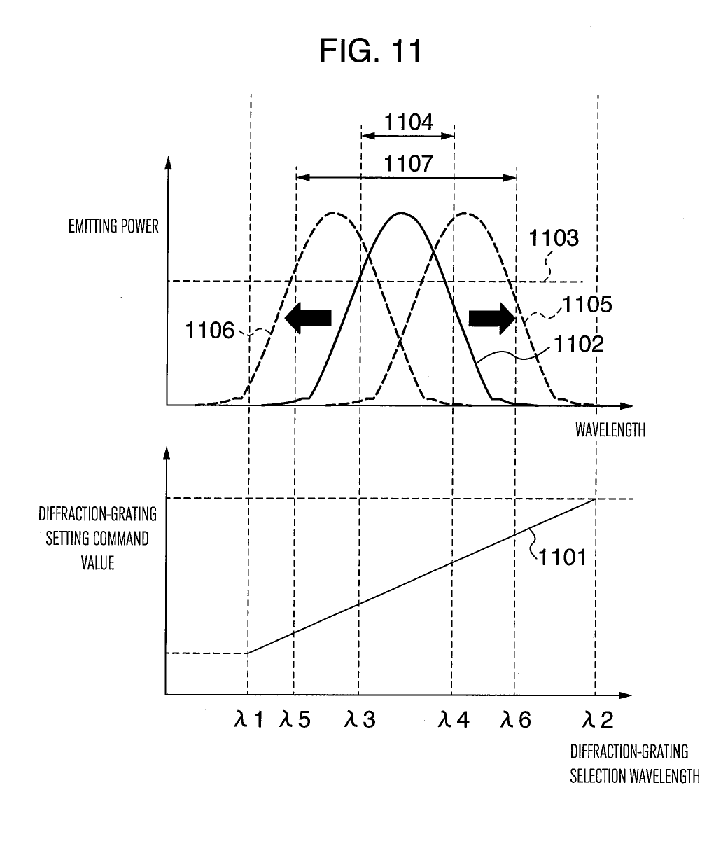

FIG. 11 is a schematic diagram for illustrating the relationship between a diffraction-grating setting command value and a diffraction-grating selection wavelength, and the relationship between the outputted laser wavelength and the emitted laser power in a wavelength-variable laser light-source. The configuration of the wavelength-variable laser light-source is basically the same as the one explained in the first embodiment of the present invention.

As indicated by 1101 of the lower graph in FIG. 11, the range of the diffraction-grating selection wavelength within which the return light to the semiconductor laser diode 301 is selected by the diffraction grating 302 is set at λ1 to λ2. This wavelength range is determined by the shape of the lattice surface of the diffraction grating 302. Meanwhile, as indicated by 1102 of the upper graph, the width of the laser oscillation spectrum (which, hereinafter, will be referred to as “spectral-line width”) of the semiconductor laser diode depends on physical properties of the semiconductor. As a result, the spectral-line width 1102 generally becomes narrower than the selection wavelength range of the diffraction grating. Moreover, the hologram recording/reproducing operation requires the emitting power and longitudinal-mode stability larger than predetermined values. Accordingly, for example, the actually available spectral-line width falls into a range 1104 ranging from λ3 to λ4 within which the emitting power becomes larger than its threshold value 1103. In view of this situation, the wavelength-variable range is enlarged by changing the temperature of the semiconductor laser diode 301 using the temperature control element 312 in FIG. 4. Concretely, when wishing to enlarge the upper-limit value of the wavelength-variable range, the laser oscillation spectrum is shifted into a direction (indicated by 1105) in which the wavelength increases by heightening the temperature of the semiconductor laser diode 301. Similarly, when wishing to enlarge the lower-limit value of the wavelength-variable range, the laser oscillation spectrum is shifted into a direction (indicated by 1106) in which the wavelength decreases by lowering the temperature of the semiconductor laser diode 301. This makes it possible to enlarge the above-described wavelength-variable range, within which the emitting power and longitudinal-mode stability larger than the predetermined values can be ensured, from the conventional range 1104 ranging from λ3 to λ4 to a range 1107 ranging from λ5 to λ6.

In the above-described method, the diffraction grating 302, which determines the outputted wavelength from the wavelength-variable laser light-source, does not undergo a temperature influence by the semiconductor laser diode 301. This feature allows the diffraction grating 302 to be controlled independently of the control over the oscillation spectrum of the semiconductor laser diode 301, thereby making it possible to enlarge the wavelength-variable range while ensuring the accuracy of the outputted laser wavelength.

### Embodiment 4

As illustrated in FIG. 15, the hologram recording medium is configured such that a recording material 1503 is sandwiched from above and below between substrates 1501 and 1502 formed of glass, resin, or the like. This is because the rigidity of the recording material 1503, which is a polymer, is low. Meanwhile, when acquiring the temperature of the hologram medium, its non-contact measurement becomes necessary, considering the influence exerted on the recording/reproducing operation. As non-contact temperature acquiring methods, there exist such methods as the temperature acquisition using infrared-rays-used IR sensor. Whatever of these methods, however, results in the acquisition of temperatures of the substrates existing on the medium surfaces. Accordingly, there exists a problem that it is difficult to measure the temperature of the recording material itself with high accuracy. Also, in the wavelength-variable laser light-source, it is also difficult to acquire the laser temperature with high accuracy.

In view of the above-described situation, as a fourth embodiment of the present invention, the explanation will be given below concerning a technique of controlling the laser temperature by acquiring a change in the apparatus temperature at the hologram recording time. Concretely, a compensation control is performed over a separation between a change in the medium temperature and a change in the laser temperature, the separation being caused by a change in the apparatus temperature at the recording time.

Concerning the above-described separation compensation control, referring to the drawings, the detailed explanation will be given below regarding the configuration and operation of the hologram recording/reproducing apparatus.

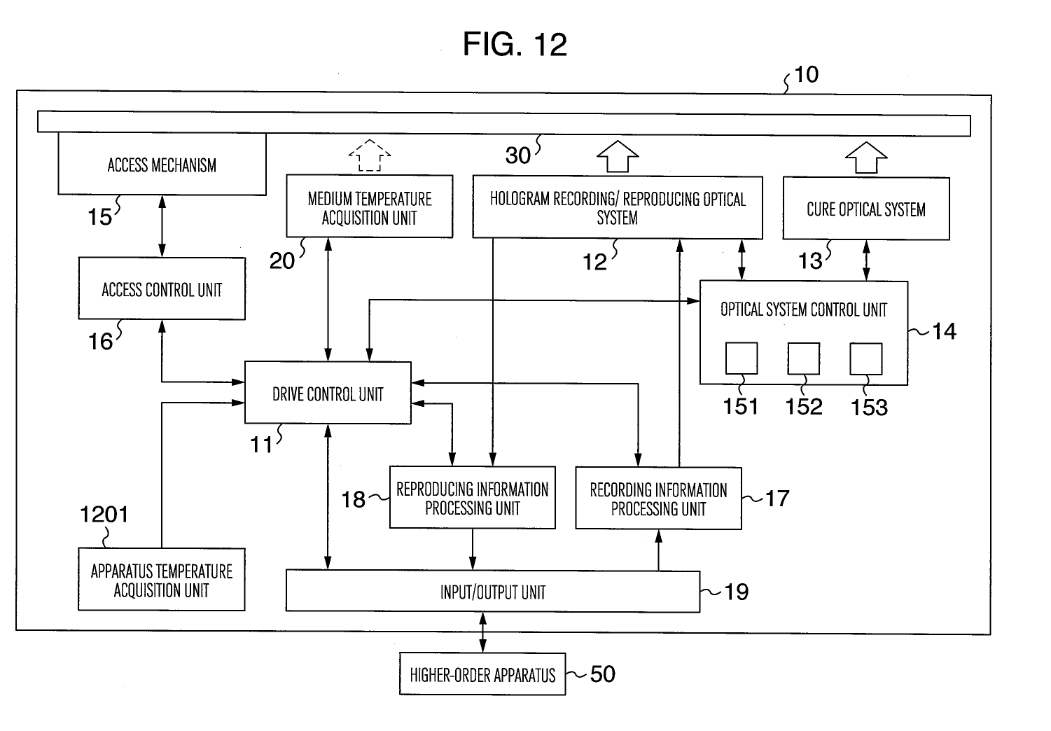

FIG. 12 is a block diagram of the hologram recording/reproducing apparatus 10 in the fourth embodiment of the present invention. In FIG. 12, the same reference numerals are affixed to the blocks and parts which have the same functions illustrated in FIG. 2. The point which differs from the configuration in FIG. 2 is a point that an apparatus temperature acquisition unit 1201 is provided. It is assumed that the configuration of the apparatus and the configuration of the wavelength-variable laser light-source are the same as the ones in FIG. 2, FIG. 3, and FIG. 4, respectively.

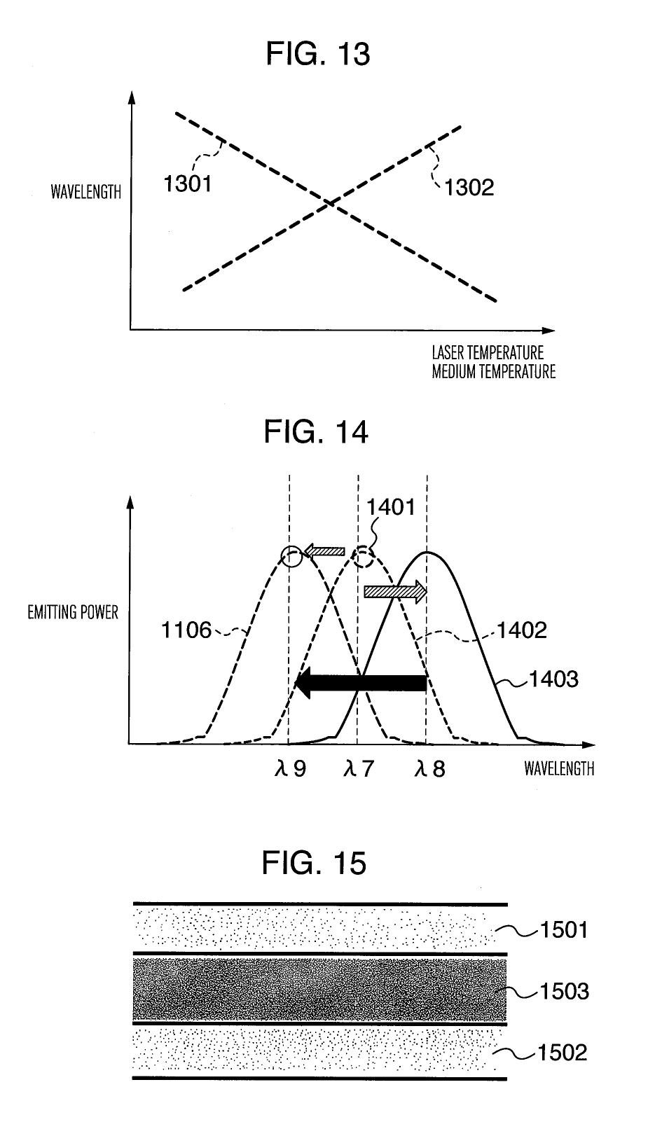

If the apparatus temperature rises, the temperature of the recording medium, and the temperature of the semiconductor laser diode 301 inside the wavelength-variable laser light-source 101 rise in accompaniment therewith. In FIG. 13, a reference numeral 1301 indicates the relative change in the emitted laser wavelength with respect to the temperature rise in the semiconductor laser diode 301, and 1302 indicates the relative change in the optimum recording laser wavelength with respect to the medium temperature. The polarities of the changes of 1301 and 1302 are inverted to each other. This situation requires that the polarity of the change in the temperature of the semiconductor laser diode 301 inside the wavelength-variable laser light-source 101 be so controlled as to become inverted with respect to the change in the apparatus temperature.

Referring to FIG. 14, a concrete example of the above-described control will be explained below. Consideration is given to the case where the apparatus temperature rises by the amount of 10° C. in the hologram recording/reproducing apparatus 10 which uses the 405-nm blue semiconductor laser light. The general temperature-wavelength behavior characteristics of the semiconductor laser light is 0.05 nm/° C. Accordingly, when the central wavelength of the laser oscillation spectrum 1402 before the temperature change is set at λ7, the central wavelength of the laser oscillation spectrum 1403 after the 10-° C. apparatus-temperature change becomes larger by the amount of 0.5 nm (: λ8 in FIG. 14). Meanwhile, the medium temperature is also caused to rise by the rise in the apparatus temperature. Consequently, in order to record a hologram which is basically the same as the one recorded at the optimum recording laser wavelength λ7 before the temperature change, the recording laser wavelength is required to be shortened from λ7 to λ9. This requirement further requires that the semiconductor laser diode be cooled by the temperature control element 312 of the wavelength-variable laser light-source. The cooling-temperature width becomes equal to the sum-total of the amount of the apparatus-temperature rise and a temperature needed for changing the central wavelength of the laser oscillation spectrum from λ7 to λ9. This temperature is settable only if the laser's temperature-wavelength behavior characteristics is acquired in advance. In the case where the apparatus temperature lowers, a control reverse to the above-described control will be performed.

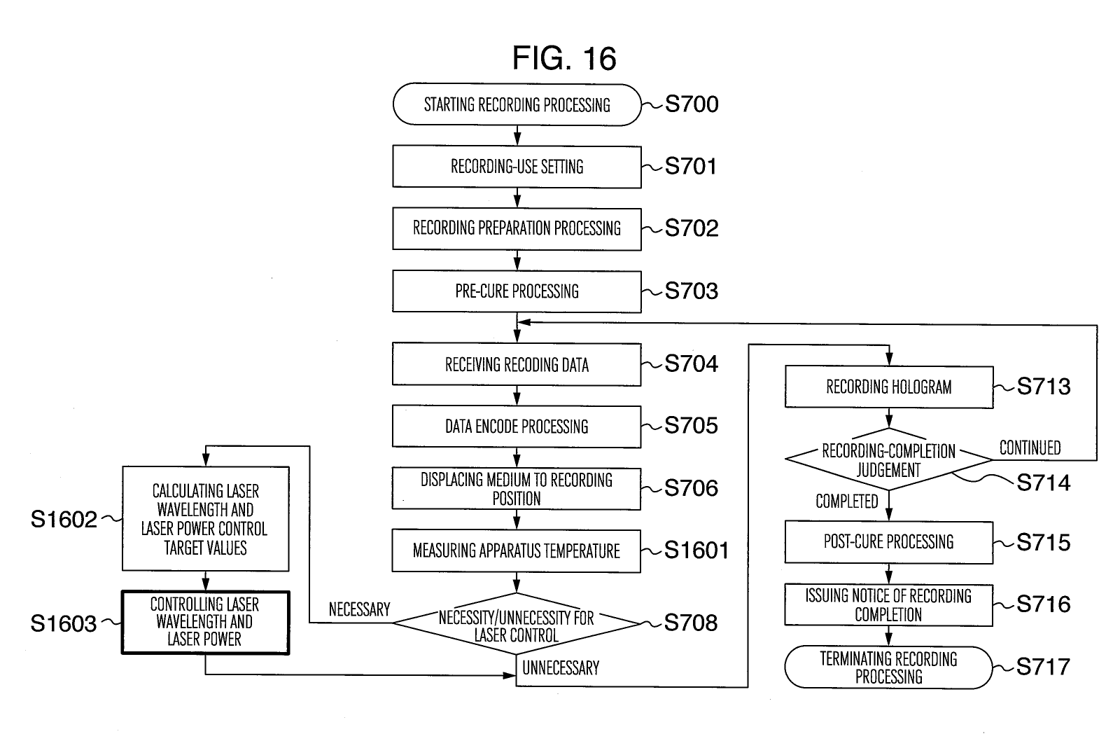

FIG. 16 illustrates a flowchart for the laser light-source control at the hologram recording time to which the above-described processing is applied. The point which differs from the first embodiment in FIG. 7 is a point that an apparatus temperature measuring processing S1601 is employed instead of the medium temperature measuring processing at S707. Also, in the fourth embodiment, as explained above, the laser temperature control quantity is directly calculated from the apparatus temperature. Accordingly, the laser wavelength control processing at 5709 and S710 in FIG. 7 are different from the ones in the first embodiment. On account of this, these processings are distinguished therefrom as being processings S1602 and S1603.

As having been explained so far, in the hologram recording method in the present embodiment, when compared with the first embodiment, the laser wavelength and laser power control target values of the wavelength-variable laser light-source can be calculated directly from the acquisition of the apparatus temperature alone. This allows the optimum recording laser wavelength and recording laser power at the hologram recording time to be controlled with high accuracy, thereby making it possible to ensure the stable recording quality.

### Embodiment 5

As a fifth embodiment of the present invention, the explanation will be given below regarding an example where the laser wavelength control method explained in the above-described fourth embodiment is applied to the information reproducing time from the hologram medium. The configuration of the apparatus and the configuration of the wavelength-variable laser light-source are the same as the one in the fourth embodiment. Accordingly, the explanation thereof will be omitted here.

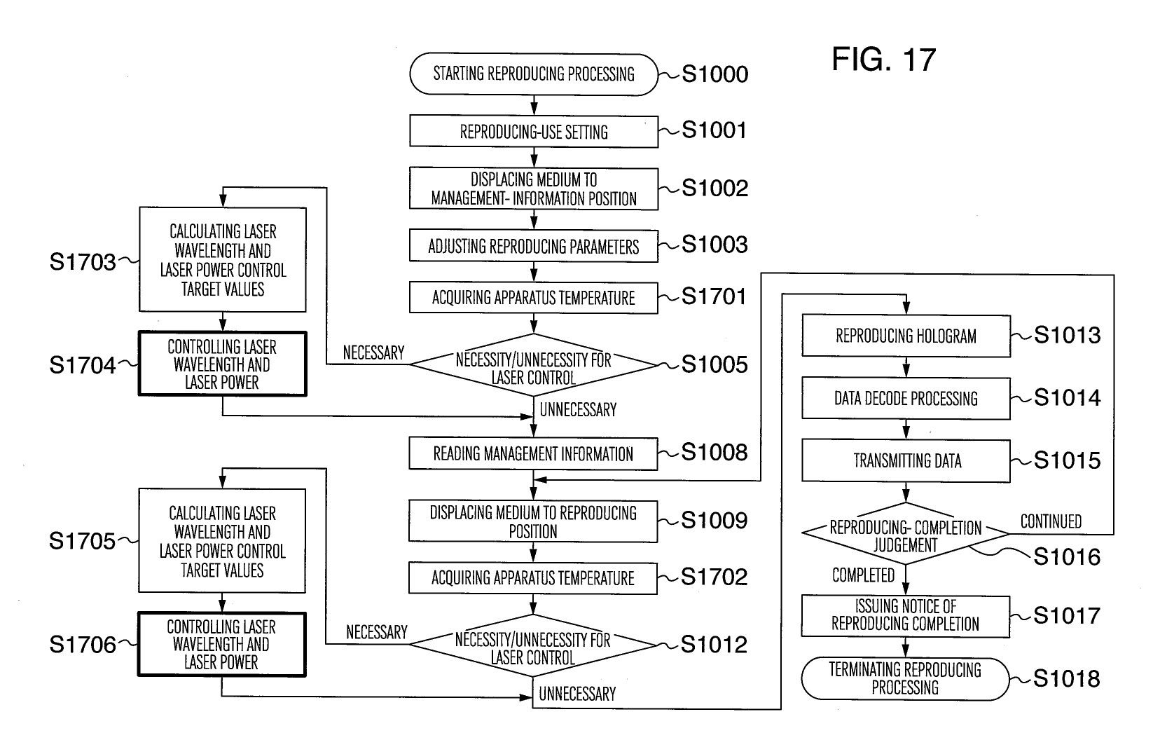

FIG. 17 illustrates a flowchart for the hologram reproducing method in the present embodiment. The point which differs from the configuration in FIG. 10 is a point that apparatus temperature acquiring processings S1701 and S1702 are employed instead of the medium temperature acquiring processings S1004 and S1019. Also, in the fifth embodiment, as explained in the above-described fourth embodiment, the laser temperature control quantity is directly calculated from the apparatus temperature. Accordingly, the laser wavelength control processings at S1006, S1007, S1010, and S1011 in FIG. 10 are different from the ones in the second embodiment. On account of this, these processings are distinguished therefrom as being processings S1703 to S1706.

As having been explained so far, in the hologram reproducing method in the present embodiment, when compared with the second embodiment, the laser wavelength and laser power control target values can be calculated from the acquisition of the apparatus temperature alone. This allows the optimum recording laser wavelength and recording laser power at the hologram reproducing time to be controlled with high accuracy, thereby making it possible to ensure the stable reproducing quality.

### Embodiment 6

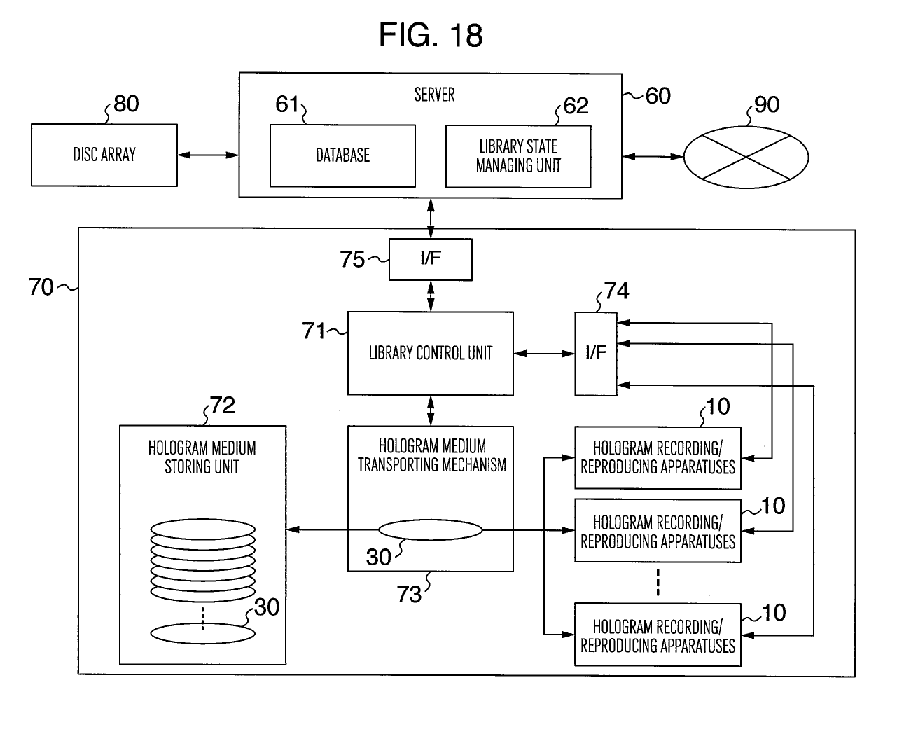

FIG. 18 is a block diagram of a data archiving system in a sixth embodiment of the present invention. The data archiving system in the present embodiment includes a system control server 60 which is connected to a network 90, a library apparatus 70 which is connected to the system control server 60, and a disc array 80.

The library apparatus 70 includes a library control unit 71, a hologram medium transporting mechanism 73, a hologram medium storing unit 72, a plurality of hologram media stored into the hologram medium storing unit 72, a host interface 75, a drive interface 74, and the one or more hologram recording/reproducing apparatuses 10.

The library apparatus 70 is connected to the system control server 60 via the host interface 75. The library apparatus 70 receives respective types of commands and data to be recorded into a predetermined hologram medium 30, and transmits execution results of the commands and the data reproduced from the predetermined hologram medium 30. The library control unit 71 is equipped with a function of controlling the entire operation of the library apparatus 70. The library control unit 71 is connected to the hologram recording/reproducing apparatuses 10 via the drive interface 74. The library control unit 71 receives, from a predetermined hologram recording/reproducing apparatus 10, the respective types of commands such as recoding command and reproducing command, and the data to be recorded into a predetermined hologram medium 30. Moreover, the library control unit 71 transmits, to the predetermined hologram recording/reproducing apparatus 10, the execution results of the commands and the data reproduced from the predetermined hologram medium 30. Namely, the library control unit 71 corresponds to the higher-order apparatus 50 in the first embodiment. Also, the library control unit 71 operates the hologram medium transporting mechanism 73, thereby extracting a predetermined hologram medium 30 from the hologram medium storing unit 72, and transporting this medium 30 to the hologram recording/reproducing apparatus 10 to insert it therein. Otherwise, conversely, the library control unit 71 transmits, to a predetermined hologram recording/reproducing apparatus 10, a command of ejecting a predetermined hologram medium 30, and transports the ejected hologram medium 30 to the hologram medium storing unit 72 to store it therein.

The system control server 60 controls the disc array 80 and the library apparatus 70. The system control server 60 is equipped with a file interface. Then, the server 60 stores, into the disc array 80, a file which the server 60 has received from an external system via the network 90. Also, the server 60 is equipped with a function of transferring the file, which is stored into the disc array 80, to the library apparatus 70 in accordance with a predetermined policy. Namely, a hierarchical storage is configured by the system control server 60, the disc array 80, and the library apparatus 70. Also, the disc array 80 functions as a buffer memory of the library apparatus 70. The system control server 60 is equipped with a library state managing unit 62 for managing the state of the library apparatus 70. Then, the server 60 manages each type of operation history of the library apparatus 70 by using a database 61.

The disc array 80 is an external memory apparatus which mounts thereon a plurality of hard-disc drives or solid-state drives. The present invention, however, is not limited to this configuration. For example, a configuration is implementable where one or more hard-disc drives or solid-state drives are built in the system control server 60.

The hologram recording/reproducing apparatus 10 and the hologram recording method in the present embodiment are basically the same as the ones in the first embodiment. At S112 illustrated in FIG. 1, if the laser temperature control amount Δt exceeds the laser tolerable temperature variable range t_max, and if the abnormal termination at S113 holds, a hologram recording/reproducing apparatus 10 corresponding thereto issues a notice of stop of the recording/reproducing processing to the higher-order apparatus 50, i.e., the library control unit 71. Moreover, based on this notice, the library control unit 71 prohibits the recording/reproducing processing by the corresponding hologram recording/reproducing apparatus 10, and will not issue a recording/reproducing command. Also, the unit 71 issues, to the system control server 60, a notice to the effect that the state of the corresponding hologram recording/reproducing apparatus 10 is the recording/reproducing-prohibited state. Furthermore, based on this notice, the library state managing unit 62 updates the state management information about the library apparatus 70.

As having been explained so far, according to the present embodiment, the use of the hologram recording/reproducing apparatus makes it possible to establish the compatibility between reliability of the recording/reproducing operation of the data archiving system and the temperature-change-resistant environmental performance thereof.

Incidentally, the present invention is not limited to the above-described embodiments, but includes a variety of modified examples. For example, the above-described embodiments have been explained in detail in order to explain the present invention in an easy-to-understand manner. Namely, the above-described embodiments are not necessarily limited to the ones which include all of the configurations explained. Also, the configuration of another embodiment can be added to the configuration of a certain embodiment. Also, the addition, deletion, and replacement of another configuration can be performed with respect to a partial configuration of each embodiment.

Also, a partial configuration or the entire configuration of each of the above-described respective configurations may be configured with hardware, or may be so configured as to be implemented by processor's executing programs. Also, only the control lines and information lines are indicated which are considered as being necessary from the explanation's point-of-view. Namely, all of the control lines and information lines are not necessarily indicated from the product's point-of-view. It may also be considered that, actually, almost all of the configurations are connected to each other.

1. A hologram recording/reproducing apparatus for recording information as a hologram by irradiating a signal light and a reference light onto a hologram medium, said information being superimposed on said signal light,
said hologram recording/reproducing apparatus, comprising:
an operation control unit for controlling the internal operation of said hologram recording/reproducing apparatus;
a wavelength-variable laser light-source which is capable of changing the wavelength of its laser light within a predetermined range, and which is the light source of said signal light and said reference light; and
a temperature control element for controlling the temperature of the laser light-emission part of said wavelength-variable laser light-source, wherein,
when changing the wavelength of said signal light and said reference light, said temperature of said laser light-emission part of said wavelength-variable laser light-source is changed by said temperature control element.

2. The hologram recording/reproducing apparatus according to claim 1, further comprising:
temperature measuring means for measuring the temperature of said hologram medium, and wherein,
based on said temperature of said hologram medium measured by said temperature measuring means, said temperature of said laser light-emission part of said wavelength-variable laser light-source is changed by said temperature control element.

3. The hologram recording/reproducing apparatus according to claim 1, wherein,
when a finite difference is larger than a predetermined value, said finite difference being a difference between the control central wavelength of said wavelength-variable laser light-source, and the central wavelength of a laser output of said wavelength-variable laser light-source to be set, said temperature of said laser light-emission part of said wavelength-variable laser light-source is changed by said temperature control element.

4. The hologram recording/reproducing apparatus according to claim 1, further comprising:
temperature measuring means for measuring the temperatures of at least one or more locations inside said hologram recording/reproducing apparatus, and wherein,
based on said temperatures measured by said temperature measuring means, said temperature of said laser light-emission part of said wavelength-variable laser light-source is changed by said temperature control element.

5. The hologram recording/reproducing apparatus according to claim 1, wherein,
when the temperature command value to said temperature control element is higher than a first threshold value, or is lower than a second threshold value, said operation control unit interrupts said recording or reproducing processing by said hologram recording/reproducing apparatus.

6. A hologram recording method for recording information as a hologram by irradiating a signal light and a reference light onto a hologram medium, said information being superimposed on said signal light,
said hologram recording method, comprising the steps of:
changing the wavelength of said signal light and said reference light by changing the temperature of the laser light-emission part of a wavelength-variable laser light-source by using a temperature control element, said wavelength-variable laser light-source being the light source of said signal light and said reference light; and
recording said information by using said signal light and said reference light whose wavelength is changed.

7. The hologram recording method according to claim 6, further comprising the steps of:
measuring a change in the temperature of said hologram medium; and
changing said temperature of said laser light-emission part of said wavelength-variable laser light-source by using said temperature control element on the basis of said measurement result.

8. The hologram recording method according to claim 6, further comprising the steps of:
detecting a finite difference between the control central wavelength of said wavelength-variable laser light-source, and the central wavelength of a laser output of said wavelength-variable laser light-source to be set; and
changing said temperature of said laser light-emission part of said wavelength-variable laser light-source by using said temperature control element when said finite difference is larger than a predetermined value.

9. The hologram recording method according to claim 6, further comprising the steps of:
measuring the temperatures of at least one or more locations inside a hologram recording/reproducing apparatus, said hologram recording/reproducing apparatus being used for recording said information as said hologram into said hologram medium, and reproducing said information from said hologram medium; and
changing said temperature of said laser light-emission part of said wavelength-variable laser light-source by said temperature control element on the basis of said measured temperatures.

10. The hologram recording method according to claim 6, further comprising the steps of:
judging whether the temperature command value to said temperature control element is higher than a predetermined first threshold value, or lower than a predetermined second threshold value; and
interrupting said recording or reproducing processing by said hologram recording/reproducing apparatus when said temperature command value to said temperature control element is higher than said predetermined first threshold value, or is lower than said predetermined second threshold value.

11. A hologram reproducing method for reproducing information by irradiating a reference light onto a hologram medium, said information being recorded into said hologram medium,
said hologram reproducing method, comprising the steps of:
changing the wavelength of said reference light by changing the temperature of the laser light-emission part of a wavelength-variable laser light-source by using a temperature control element, said wavelength-variable laser light-source being the light source of said reference light; and
reproducing said information by using said reference light whose wavelength is changed.

12. The hologram reproducing method according to claim 11, further comprising the steps of:
measuring a change in the temperature of said hologram medium; and
changing said temperature of said laser light-emission part of said wavelength-variable laser light-source by using said temperature control element on the basis of said measurement result.

13. The hologram reproducing method according to claim 11, further comprising the steps of:
detecting a finite difference between the control central wavelength of said wavelength-variable laser light-source, and the central wavelength of a laser output of said wavelength-variable laser light-source to be set; and
changing said temperature of said laser light-emission part of said wavelength-variable laser light-source by using said temperature control element when said finite difference is larger than a predetermined value.

14. The hologram reproducing method according to claim 11, further comprising the steps of:
measuring the temperatures of at least one or more locations inside a hologram recording/reproducing apparatus, said hologram recording/reproducing apparatus being used for recording said information as said hologram into said hologram medium, and reproducing said information from said hologram medium; and
changing said temperature of said laser light-emission part of said wavelength-variable laser light-source by said temperature control element on the basis of said measured temperatures.

15. The hologram reproducing method according to claim 11, further comprising the steps of:
judging whether the temperature command value to said temperature control element is higher than a predetermined first threshold value, or lower than a predetermined second threshold value; and
interrupting said reproducing processing by said hologram recording/reproducing apparatus when said temperature command value to said temperature control element is higher than said predetermined first threshold value, or is lower than said predetermined second threshold value.

16. A data archiving system, comprising:
a library apparatus including a hologram medium, and a hologram recording/reproducing apparatus for recording/reproducing information into/from said hologram medium; and
a control apparatus for controlling said library apparatus,
said hologram recording/reproducing apparatus, comprising:
an operation control unit for controlling the operation of said hologram recording/reproducing apparatus;
a wavelength-variable laser light-source which is capable of changing the wavelength of its outputted laser light within a predetermined range in accordance with a signal from said operation control unit, and which is the light source of a signal light and a reference light; and
a temperature control element for controlling the temperature of the laser light-emission part of said wavelength-variable laser light-source in accordance with a signal from said operation control unit, wherein,
said operation control unit interrupts said recording or reproducing processing by said hologram recording/reproducing apparatus when the temperature command value to said temperature control element is higher than a predetermined first threshold value, or is lower than a predetermined second threshold value,
said hologram recording/reproducing apparatus issuing, to said library apparatus, a notice of said interruption of said recording or reproducing processing, said hologram recording/reproducing apparatus then updating state management information about said library apparatus on the basis of said notice issued to said library apparatus.
